(19) United States
(12) Patent Application Publication
(10) Pub. No.: US 2011/0146638 A1
(43) Pub. Date: Jun. 23, 2011

(54) BLOW-BY GAS RECIRCULATION SYSTEM

(75) Inventor: Satoshi WADA, Hamamatsu-Shi (JP)

(73) Assignee: SUZUKI MOTOR CORPORATION, Hamamatsu-Shi (JP)

(21) Appl. No.: 12/964,351

(22) Filed: Dec. 9, 2010

(30) Foreign Application Priority Data
Dec. 17, 2009 (JP) 2009-285991

(51) Int. Cl. F02B 25/06

(52) U.S. Cl. 123/573

(57) ABSTRACT

A vehicle includes an engine mounted in an engine room with a crankshaft oriented in a width direction of the vehicle, a turbo-supercharger, an exhaust manifold, an air cleaner placed on a lateral side of the turbo-supercharger, an air intake hose connecting the turbo-supercharger and the air cleaner, and a blow-by gas recirculation system provided for the engine. The blow-by gas recirculation system includes a blow-by gas outlet provided in the engine, a blow-by gas inlet provided in the air intake hose, a blow-by gas recirculation pipe connecting the blow-by gas outlet and the blow-by gas inlet to each other. The blow-by gas recirculation pipe is provided with a heat receiver adapted to receive heat from the exhaust manifold disposed close to an end portion of the exhaust manifold, and the heat receiver and a passageway extending from the heat receiver to the blow-by gas inlet are arranged behind the air intake hose in a front-rear direction of the vehicle in a side view thereof.

### BACKGROUND OF THE INVENTION

1. Field of the Invention

The present invention relates to a blow-by gas recirculation system particularly for re-circulating an engine blow-by gas to an intake system of an engine of a vehicle.

2. Description of the Related Art

In a diesel engine mounted on a vehicle such as a four-wheel vehicle, blow-by gas is generated in a crankcase. The blow-by gas, which contains oil, mist and unburned gas, must not be released into the atmosphere. Therefore, the blow-by gas needs to be return back to the intake system and burned therein. Thus, there is a fear that the blow-by gas containing moisture may be frozen in a cold atmosphere, which clogs a return path to the intake system and/or the intake system itself.

Japanese Patent Laid-Open Publication No. 2004-204720 (Patent Document 1) discloses a blow-by gas recirculation system which heats a blow-by gas passage by branching a blow-by gas passage heating channel from a heater channel running between an engine and a heater core to thereby enhance heating efficiency of the blow-by gas passage.

Conventionally, in blow-by gas recirculation systems, in order to prevent the blow-by gas from freezing, it is common practice to heat the blow-by gas by leading a cooling water pipe to a path of the blow-by gas and placing the cooling water pipe in close contact with a blow-by gas pipe or by installing an electric heater.

However, in the above-described structure or method, a path of the cooling water pipe and a path of a breather pipe are arranged close to each other, and accordingly, it becomes necessary to detour one of these paths by extending the pipe or the like and also necessary to additionally install an electric heater for the path of the blow-by gas. Such arrangement is inconvenient and involves cost increasing for the addition of parts or components or extension of the piping path.

Furthermore, in order to prevent freezing of piping into which the blow-by gas flows and to prevent freezing of moisture contained in the blow-by gas, it has been required for the blow-by gas recirculation system to keep piping temperature from falling too low in cold weather.

To obviate the inconveniences or defects mentioned above encountered in the prior art, there is a technique, such as described in Patent Document 1, for circulating hot water (cooling water) around a blow-by gas recirculation pipe (or blow-by gas passage) to thereby prevent the freezing of the blow-by gas recirculation pipe due to temperature falling.

However, with the structure disclosed in the Patent Document 1, it is also necessary to place the blow-by gas recirculation pipe in the same space as the piping which passes the hot water to the blow-by gas recirculation pipe, resulting in not only requiring of a sufficient location space, but also leading of a complicated piping structure.

### SUMMARY OF THE INVENTION

In consideration of the circumstances of the conventional art described above, an object of the present invention is to provide a blow-by gas recirculation system capable of preventing freezing of blow-by gas in cold weather by heating a blow-by gas recirculation pipe by utilizing heat from an exhaust manifold and suppressing cooling influence due to wind flow.

The above and other objects can be achieved according to the present invention by providing, in a preferred aspect, a blow-by gas recirculation system used for an engine of a vehicle including the engine mounted in an engine room with a crankshaft oriented in a width direction of the vehicle, a turbo-supercharger attached to a front portion of the engine via an exhaust manifold, an air cleaner placed on a lateral side of the turbo-supercharger, an air intake hose connecting the turbo-supercharger and the air cleaner to each other, and a blow-by gas recirculation system provided for the engine, the blow-by gas recirculation system comprising:

a blow-by gas outlet provided for the engine;

a blow-by gas inlet provided for the air intake hose;

a blow-by gas recirculation pipe connecting the blow-by gas outlet and the blow-by gas inlet to each other,

wherein the blow-by gas recirculation pipe is provided with a heat receiver adapted to receive heat from the exhaust manifold disposed close to an end portion of the exhaust manifold, and the heat receiver and a passageway extending from the heat receiver to the blow-by gas inlet are arranged behind the air intake hose in a front-rear direction (i.e., longitudinal direction along a vehicle body) of the vehicle in a side view thereof.

In a preferred embodiment, the following arrangements may be preferably adopted.

It may be desired that the air intake hose is arranged so as to be inclined in a manner extending obliquely upward from a connecting portion of the turbo-supercharger toward a front portion of the vehicle in the side view thereof.

The exhaust manifold may be fitted with an exhaust manifold cover, and blow-by gas recirculation pipe is coupled to the exhaust manifold cover via a bracket.

The blow-by gas recirculation pipe may include a first recirculation pipe segment connecting the blow-by gas outlet and a second recirculation pipe segment connected to the blow-by gas inlet, and an oil separator may be disposed between the first recirculation pipe segment and the second recirculation pipe segment of the blow-by gas recirculation pipe for separating oil and mist from each other.

It may be also desired that the first recirculation pipe segment of the blow-by gas recirculation pipe is provided with the heat receiver at a portion closer to the intake hose.

The blow-by gas recirculation system according to the present invention of the structure mentioned above can prevent the blow-by gas from freezing in cold weather by heating the blow-by-gas recirculation pipe by utilizing the heat from the exhaust manifold and by suppressing cooling influence due to wind flow.

The nature and further characteristic features of the present invention will be made further clearer from the following description made with reference to the accompanying drawings.

### BRIEF DESCRIPTION OF THE DRAWINGS

In the accompanying drawings:

FIG. 1 is a perspective view of front part of a vehicle shown by an arrow I in FIG. 2 according to an embodiment of the present invention;

FIG. 2 is a plan view of the front part of the vehicle according to the embodiment;

FIG. 3 is a side view of the front part of the vehicle according to the embodiment;

FIG. 4 is a front view of the front part of the vehicle according to the embodiment;

FIG. 5 is a rear view of the front part of the vehicle according to the embodiment; and

FIG. 6 is a perspective view of front part of a vehicle according to a modified embodiment of the present invention.

### DESCRIPTION OF THE PREFERRED EMBODIMENT

The present invention provides a blow-by gas recirculation system of a vehicle to achieve an object of preventing blow-by gas from freezing in cold weather by heating a blow-by gas recirculation pipe by utilizing heat from an exhaust manifold and suppressing cooling influence due to wind flow, and by forming a heat receiver on the blow-by gas recirculation pipe close to an end of the exhaust manifold so as to receive heat from the exhaust manifold.

### Embodiment

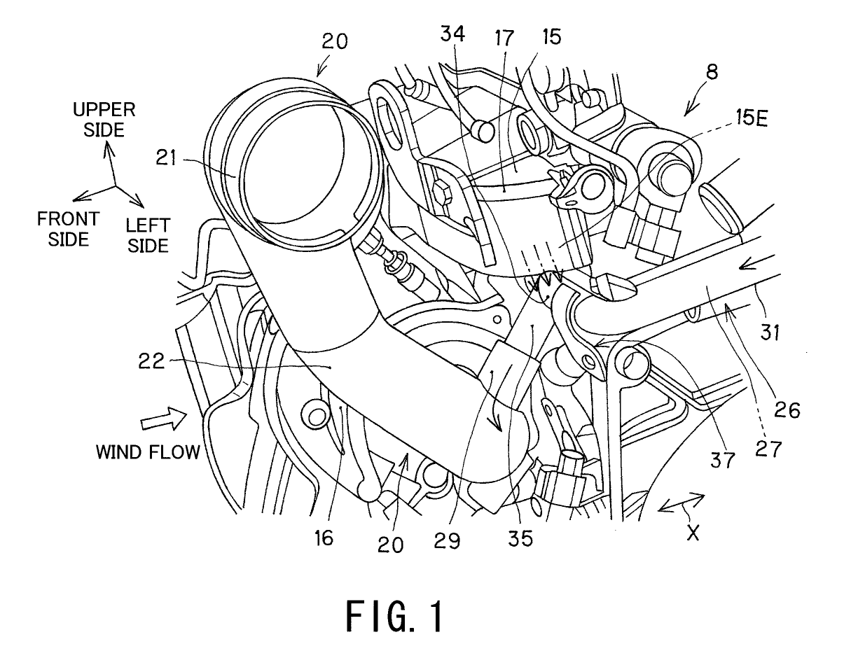

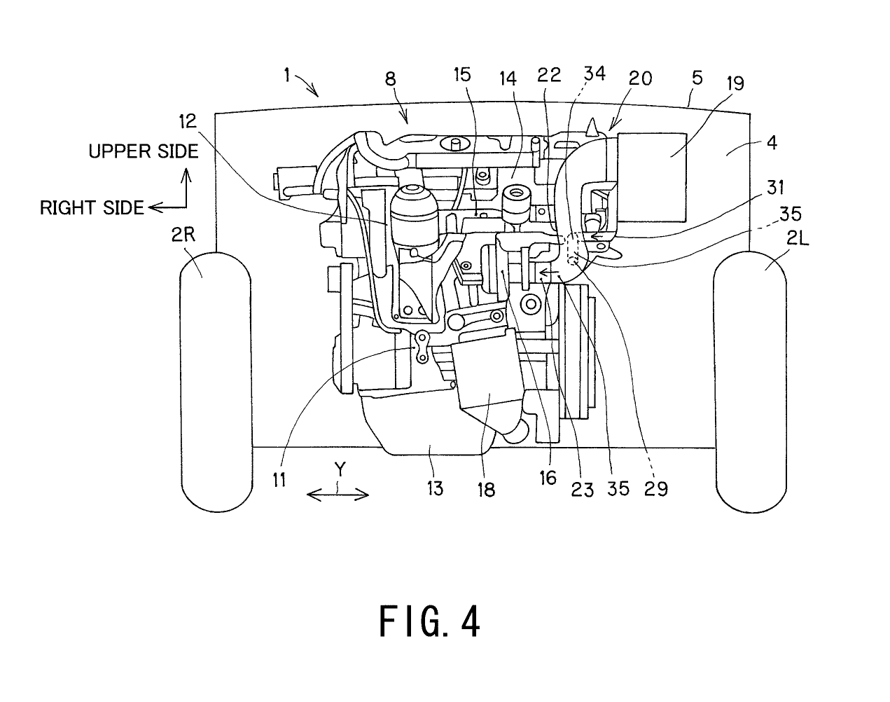

FIGS. 1 to 5 show an embodiment of the present invention, in which, it is to be noted that terms “upper”, “lower”, “right”, “left” and like terms indicating direction or the like are used as indicated by arrows in the drawings.

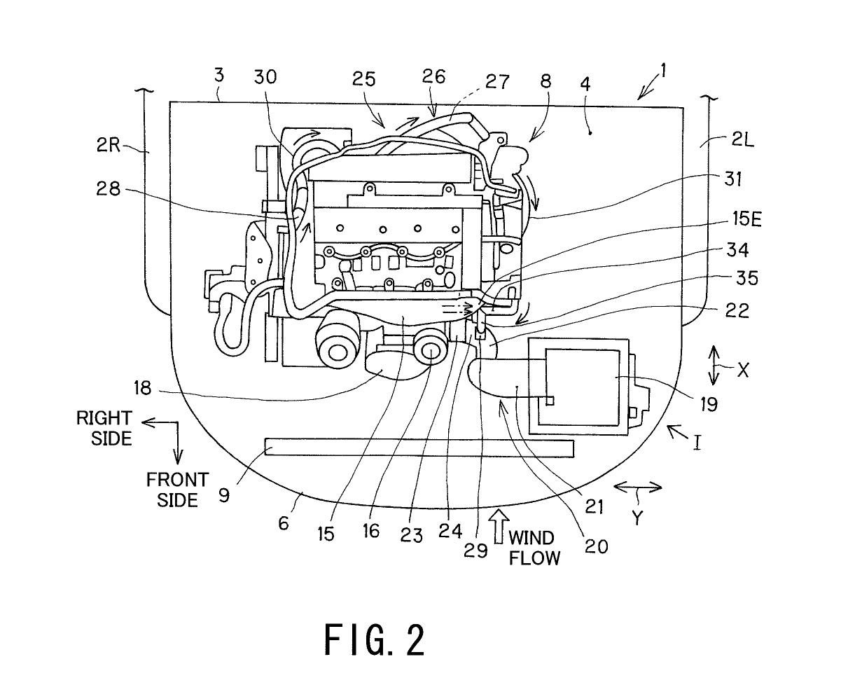

With reference to FIGS. 2 to 5, reference numeral 1 denotes a vehicle such as a four-wheel vehicle, which is provided with a right front wheel 2R, a left front wheel 2L, a dash panel 3, an engine room 4 in which an engine, for example, a diesel engine 8 is mounted, an engine hood 5, a front bumper 6, and an opening 7 through which wind flow is introduced into the engine room 4.

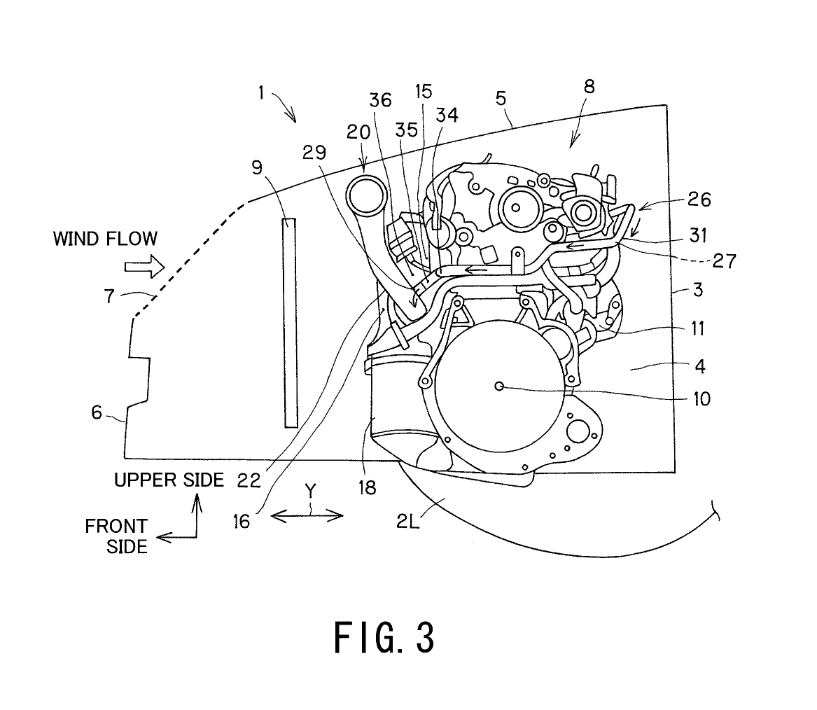

In the vehicle 1, the diesel engine (hereinafter referred to simply as an “engine”) 8 is mounted in the engine room 4 with a crank shaft 10 oriented in the vehicle's width direction Y orthogonal to a front-rear direction X of the vehicle (i.e., longitudinal direction along a vehicle body) as shown in FIGS. 2 and 3, and a radiator 9 is disposed in front of the engine 8.

As shown in FIGS. 3 to 5, the engine 8 includes a cylinder block 11, a cylinder head 12, an oil pan 13 located at the bottom of the cylinder block 11, and a cylinder head cover 14 located on top of the cylinder head 12.

As shown in FIGS. 2 to 4, an exhaust manifold 15 is attached to front part of the engine 8 and a turbo-supercharger 16 is attached via the exhaust manifold 15. The exhaust manifold 15 acts as a heat source by being heated by exhaust heat from the engine 8. The exhaust manifold 15 is fitted with an exhaust manifold cover 17 and connected with a catalyst converter 18 extending downward.

An air cleaner 19 is disposed on a lateral side (in upper left front part of the vehicle) of the turbo-supercharger 16. The turbo-supercharger 16 and air cleaner 19 are interconnected via an air intake hose 20.

The air intake hose 20 is composed of an upstream piping segment 21 connected to the air cleaner 19, an intermediate piping segment 22 installed consecutively with the upstream piping segment 21 and extending downstream, and a downstream piping segment 24 installed consecutively with the intermediate piping segment 22 and connected to a connector 23 of the turbo-supercharger 16 so as to extend rightward.

The engine 8 is provided with a blow-by gas recirculation system 25.

The blow-by gas recirculation system 25 is equipped with a blow-by recirculation pipe 26 forming a blow-by gas passage 27 by interconnecting a blow-by gas outlet 28 and a blow-by gas inlet 29 in a manner that the blow-by gas outlet 28 is provided on the cylinder head cover 14 to serve as a connector at a starting end of a blow-by gas flow in a breather chamber in the cylinder head cover 14 while the blow-by gas inlet 29 is provided in lower part of the intermediate piping segment 22 of the air intake hose 20 to serve as a connector at a terminating end of the blow-by gas flow.

The blow-by gas recirculation pipe 26 includes a first recirculation pipe segment 30 and a second recirculation pipe segment 31, in which the first recirculation pipe segment 30 is connected to the blow-by gas outlet 28 on the right side of the cylinder head 12, subsequently extending toward the rear portion of the vehicle, turning to the left side of the vehicle, and reaching an approximate center position behind the cylinder head 12, and on the other hand, the second recirculation pipe segment 31 is connected to the blow-by gas inlet 29 of the air intake hose 20 by extending in a left direction of the vehicle from the approximate center position behind the cylinder head 12 and then extending in a front direction of the vehicle along the left side of the cylinder head 12.

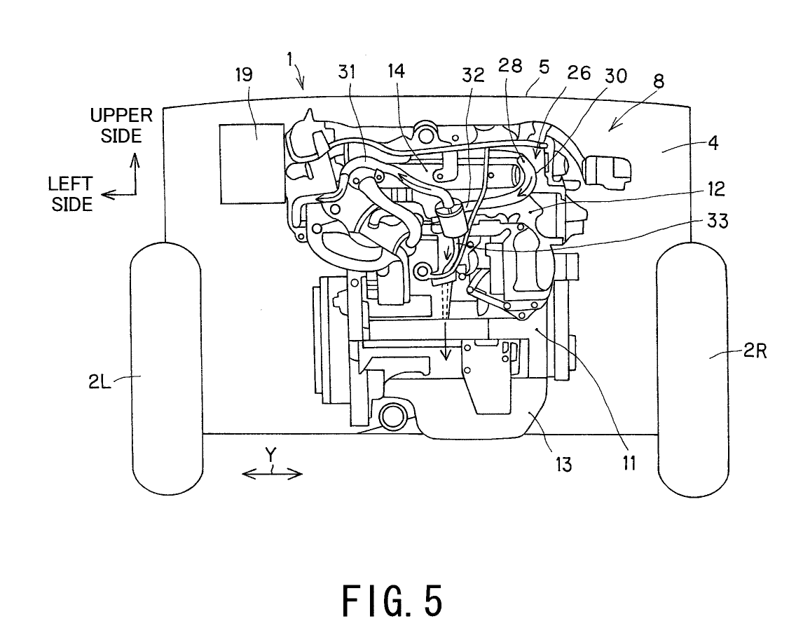

As shown in FIG. 5, an oil separator 32 is installed between the first recirculation pipe segment 30 and the second recirculation pipe segment 31 at the approximate center position behind the cylinder head 12 to separate oil from mist in the blow-by gas coming from the first recirculation pipe segment 30. The oil separator 32 is connected with an oil return pipe 33 extending downward so as to return the oil separated from the blow-by gas into the oil pan 13.

In the blow-by gas recirculation system 25, as indicated by arrows in FIGS. 1 to 5, the blow-by gas, which is a mixture of the oil and the mist, is led from the blow-by gas outlet 28 to the first recirculation pipe segment 30 and then to the oil separator 32. The oil separated from the mist is returned to the oil pan 13 through the oil return pipe 33, while the separated mist is returned to the turbo-supercharger 16 through the second recirculation pipe segment 31, blow-by gas inlet 29, and air intake hose 20.

According to the present embodiment, as shown in FIGS. 1 and 2, a heat receiver 34 is formed on the second recirculation pipe segment 31 of the blow-by gas recirculation pipe 26 on the side of the blow-by gas inlet 29 so as to receive the heat from the exhaust manifold 15 acting as a heat source by coming close to an end portion 15E of the exhaust manifold 15.

The heat receiver 34 of the second recirculation pipe segment 31 and a passageway 35 extending from the heat receiver 34 to the blow-by gas inlet 29 are arranged within a space 36 formed behind the air intake hose 20 in the front-rear direction X of the vehicle.

The heat receiver 34 is located close to the air intake hose 20 behind the intermediate piping segment 22 of the air intake hose 20 so as to be oriented in the width direction Y of the vehicle (i.e., lateral direction of the vehicle body). A fastening bracket 37 is attached to a portion of the heat receiver 34 on a side apart from the exhaust manifold 15.

Behind the intermediate piping segment 22 of the air intake hose 20, the passageway 35 extends obliquely upward in the front-rear direction X of the vehicle. Furthermore, as shown in FIG. 3, the passageway 35 is connected to the intermediate piping segment 22 of the air intake hose 20 in such a way that an axis of the passageway 35 will intersect an axis of the intermediate piping segment 22 at right angles in a side view of the vehicle.

According to the arrangement mentioned above, the heat receiver 34 which comes close to the end portion 15E of the exhaust manifold 15 is mounted to the second recirculation pipe segment 31 of the blow-by gas recirculation pipe 26 into which the blow-by gas flows, so that the heat receiver 34 is heated by the heat (indicated by chain line arrows in FIGS. 1 and 2) from the exhaust manifold 15, thereby preventing the blow-by gas containing moisture from freezing in the blow-by gas passage 27 in cold weather. Furthermore, since the heat receiver 34 is arranged close to the air intake hose 20, the blow-by gas can be heated on the side of a low-temperature intake system, thus making it possible to effectively prevent the blow-by gas from freezing.

Still furthermore, according to the described embodiment, since the heat receiver 34 of the second recirculation pipe segment 31 and the passageway 35 extending from the heat receiver 34 to the blow-by gas inlet 29 are arranged behind the air intake hose 20 in the front-rear direction X of the vehicle, the air intake hose 20 blocks the wind flow (indicated by hollow arrows in FIGS. 1 to 3) coming from the front side as shown in FIG. 1 to thereby protect the heat receiver 34 from directly exposing to the wind flow.

The blow-by gas heated by the heat receiver 34 is thus prevented from being cooled and being frozen by the wind flow in cold weather. Moreover, the cooling water and an electric heater can be eliminated, thus reducing the number of parts or components and eliminating the need for large space. This in turn results in a simplified piping structure and reduced costs.

Furthermore, the axis of the passageway 35 of the blow-by gas recirculation pipe 26 intersects the axis of the intermediate piping segment 22 of the air intake hose 20 at right angles so that the air intake hose 20 will be supported by the blow-by gas recirculation pipe 26, and the air intake hose 20 can be hence prevented from falling off.

Still furthermore, according to the present embodiment, as shown in FIGS. 1 and 3, the air intake hose 20 is arranged in an inclined manner so as to extend obliquely upward from the connector 23 of the turbo-supercharger 16 toward the front side of the vehicle in the side view of the vehicle.

As mentioned above, since the air intake hose 20 is inclined in a front direction of the vehicle from a lateral side of the turbo-supercharger 16, the inclined portion of the air intake hose 20 can guide the wind flow coming from the front side of the vehicle to the underside of the vehicle, thereby reducing entrainment of the wind flow in the space 36 formed between the air intake hose 20 and the engine 8 and preventing air temperature in the space 36 from falling. This in turn prevents the heat receiver 34 placed in the space 36 and the passageway 35 on a downstream side the space 36 from being cooled, thereby preventing the blow-by gas from freezing.

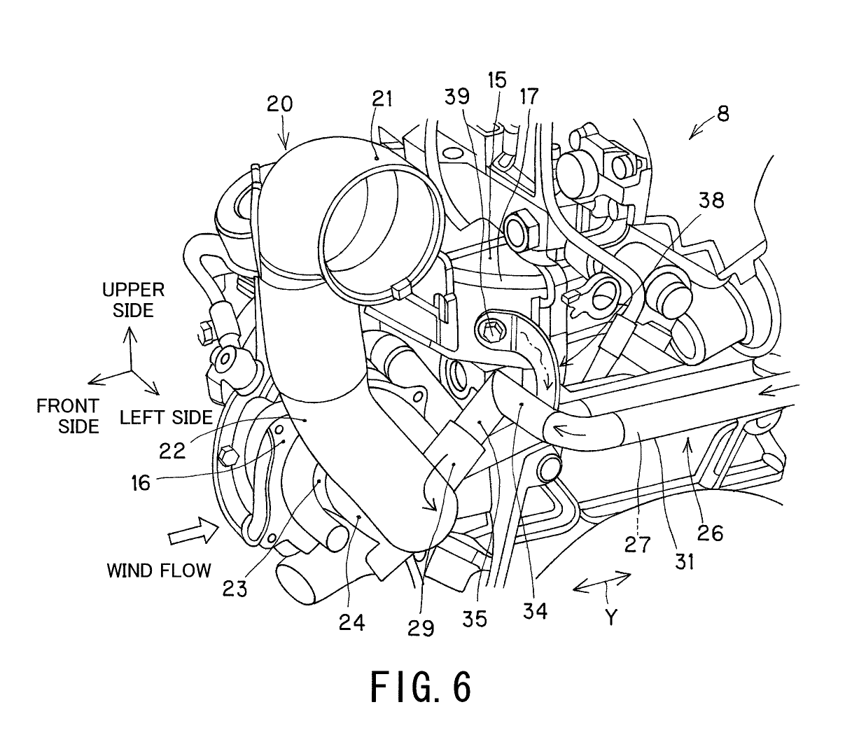

FIG. 6 represents a modified embodiment of the present invention, in which the heat receiver 34 of the second recirculation pipe segment 31 is coupled to the exhaust manifold cover 17 via a bracket 38. The bracket 38 is made of a plate member with a predetermined width in a vertical direction as viewed in the side view of the vehicle. One end portion of the bracket 38 is fastened to the exhaust manifold cover 17 with a mounting bolt 39 and the other end portion thereof is attached to the heat receiver 34 by a predetermined fixing means.

According to this structure, since the second recirculation pipe segment 31 of the blow-by gas recirculation pipe 26 and the exhaust manifold cover 17 are coupled to each other via the bracket 38, the bracket 38 can transmit the heat (indicated by a chain line in FIG. 6) received from the exhaust manifold 14 to the heat receiver 34, thereby heating the heat receiver 34. This makes it possible to effectively prevent the blow-by gas from freezing. Moreover, since the bracket 38 has a function to fasten the second recirculation pipe segment 31 of the blow-by gas recirculation pipe 26, there is no need for a special fastening bracket, which reduces the number of parts or components to be arranged.

The bracket 38 may be made of a metal material which has good heat conductive efficiently or may change its shape, and according to this modification, the blow-by gas can be prevented from freezing more effectively.

The blow-by gas recirculation system according to the present invention may be applicable not only to diesel engines, but also to various types of engines.

What is claimed is:

1. A blow-by gas recirculation system used for an engine of a vehicle including the engine mounted in an engine room with a crankshaft oriented in a width direction of the vehicle, a turbo-supercharger attached to a front portion of the engine via an exhaust manifold, an air cleaner placed on a lateral side of the turbo-supercharger, an air intake hose connecting the turbo-supercharger and the air cleaner to each other, and a blow-by gas recirculation system provided for the engine, the blow-by gas recirculation system comprising:
a blow-by gas outlet provided in the engine;
a blow-by gas inlet provided in the air intake hose;
a blow-by gas recirculation pipe connecting the blow-by gas outlet and the blow-by gas inlet to each other,
wherein the blow-by gas recirculation pipe is provided with a heat receiver adapted to receive heat from the exhaust manifold disposed close to an end portion of the exhaust manifold, and the heat receiver and a passageway extending from the heat receiver to the blow-by gas inlet are arranged behind the air intake hose in a front-rear direction of the vehicle in a side view thereof.

2. The blow-by gas recirculation system according to claim 1, wherein the air intake hose is arranged so as to be inclined in a manner extending obliquely upward from a connecting portion of the turbo-supercharger toward a front portion of the vehicle in the side view thereof.

3. The blow-by gas recirculation system according to claim 1, wherein the exhaust manifold is fitted with an exhaust manifold cover, and blow-by gas recirculation pipe is coupled to the exhaust manifold cover via a bracket.

4. The blow-by gas recirculation system according to claim 3, wherein the blow-by gas recirculation pipe includes a first recirculation pipe segment connecting the blow-by gas outlet and a second recirculation pipe segment connected to the blow-by gas inlet.

5. The blow-by gas recirculation system according to claim 4, wherein an oil separator is disposed between the first recirculation pipe segment and the second recirculation pipe segment of the blow-by gas recirculation pipe for separating oil and mist from each other.

6. The blow-by gas recirculation system according to claim 3, wherein the first recirculation pipe segment of the blow-by gas recirculation pipe is provided with the heat receiver at a portion closer to the intake hose.
